(19) United States
(12) Patent Application Publication
(10) Pub. No.: US 2009/0139930 A1
(43) Pub. Date: Jun. 4, 2009

(54) Extracorporeal Blood Cleaning

(76) Inventors: Jan Sternby, Lund (SE); Anders Wieslander, Lund (SE); Per Kjellstrand, Sodra Sandby (SE); Torbjorn Linden, Linderod (SE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/090,230

(22) PCT Filed: Sep. 25, 2006
(86) PCT No.: PCT/SE2006/050349

§ 371 Date: Oct. 1, 2008

Related U.S. Application Data
(60) Provisional application No. 60/596,822, filed on Oct. 24, 2005.

(30) Foreign Application Priority Data
Oct. 17, 2005 (SE) 0502294-2

(51) Int. Cl. B01D 61/24; B01D 63/00; B01D 61/42; B01D 61/32; B01D 61/28

(52) U.S. Cl. 210/639; 210/321.6; 210/209; 210/243; 210/151; 210/321.71; 210/104; 210/790; 210/647

(57) ABSTRACT

An apparatus (100) for extracorporeal blood cleaning includes a separation unit (110), at least two processing branches (120; 130) and a mixing unit (140). The separation unit (110) receives 5 incoming blood (B A) and divides off a first fraction (f_{C}) from this blood. The first fraction (f_{C}) contains predominantly blood cells. The separation unit (110) also divides off at least one second fraction (f_{P}), which contains predominantly blood plasma. A first processing branch (120) processes the first fraction (f_{C}) according to a first cleaning process, in which cell-bound substances are removed from the blood cells. As a result, a first cleaned fraction (f_{C c}) containing washed blood cells is produced. A second processing branch (130) processes the second fraction (f_{P}) according to a second cleaning process in which toxins bound on proteins within the plasma and/or toxins dissolved in 15 the plasma are removed, and a second cleaned fraction (f_{P c}) is produced. The second cleaning process is different from the first cleaning process. Thereby each process can be tailored for the requirements of the respective fraction (f_{C}, f_{P}). The mixing unit 20 (140) receives the first and second cleaned fractions (f_{C c}, f_{P c}, combines these fractions (f_{C c}, f_{P c}, and outputs cleaned whole blood (B_{V}).

### THE BACKGROUND OF THE INVENTION AND PRIOR ART

The present invention relates generally to extracorporeal blood cleaning. More particularly the invention relates to an apparatus according to the preamble of claim 1 and a method according to the preamble of claim 27.

The human body consists of approximately 60% water—a level which is important to maintain for survival. While it is unproblematic to provide the body with new water, disposal of surplus water is a major problem in renal patients. One task of the normal kidney is to remove superfluous fluid from the blood, such as water, urea and other waste products. The resulting urine is transferred to the bladder and finally leaves the body during urination. The kidney's second task is to regulate for example the balance of electrolytes and acid and base. With malfunctioning kidneys, disorders may develop in most major body organs, a syndrome called uremia. If uremia remains untreated, it will lead to death. Uremia is treated either by kidney transplantation or some form of extracorporeal blood cleaning, e.g. hemodialysis, hemofiltration or hemodiafiltration.

Extracorporeal blood cleaning may also be employed in connection with blood donation to a blood bank. Namely, when storing whole blood for future use, for instance in surgery, it is of utmost importance that the blood has a highest possible quality.

Today, the vast majority of all extracorporeal blood cleaning is performed on whole blood. Such processing is very good at removing undesired substances (i.e. toxins) that are dissolved in the blood plasma. In general, diffusive treatments have a higher efficiency than convective treatments for substances with a relatively low molecular weight, and for larger substances the convective transport is more efficient.

In a renal patient, the water concentration of urea is considered to be the same inside and outside of the cells. When urea is removed through dialysis from the plasma water outside the cell a concentration difference occurs across the cell. This, in turn, causes urea to diffuse out of the cell, and thus clean the cell. The transport of urea is quick because the cell wall is highly permeable to urea. In fact, the net result is that urea is removed almost as well from inside the cells as from the plasma water. However, there exist a number of substances that are not so readily available for removal by means of a dialysis-based strategy. One reason for this may be that the substances are mainly residing inside the cells, and thus also within the red blood cells. If the cell membrane is relatively impermeable with respect to the substances, the above-described equilibration of concentrations between inside and outside of the cell becomes complicated, or even impossible. Creatinine, phosphate and potassium constitute examples of substances for which the cell membrane permeability is relatively low.

Another reason for a slow dialysis removal rate may be that the substance to be removed is bound to proteins, such as albumin, residing in the plasma. Namely, the removal rate in dialysis is proportional to the concentration of the substance in the plasma water. If a large part of the substance is bound to proteins, the ratio between the removal rate and the total amount present in the blood will be smaller than for non-protein bound substances. This is due to the fact that the removal rate is proportional to the dissolved concentration, and the total amount includes both the protein bound substances and the dissolved substances. Thus, the time required for the removal increases. Bilirubin, which is a breakdown product from the normal turnover of red blood cells, is one example of a protein bound substance. Hippuric acid and paracresol represent other toxin examples of this type.

One approach to improve the dialysis removal rate is to separate the blood cells from the plasma. For instance, the published international patent application WO01/62314 discloses a hemodialysis system in which whole blood is processed in a centrifuge to separate the cells from the plasma fluid and foreign substances. The plasma fluid and foreign substances are then conveyed away from the centrifuge where the foreign substances are removed from the plasma. Thereafter, the plasma is combined with the cells to a resulting cleaned whole blood. However, there is no cleaning treatment of the cells. This means that any toxins therein remain also in the resulting whole blood.

The published international patent application WO99/20377 describes an ultradialyzer for removing toxins from a patient's blood, wherein the blood is divided into two portions. One portion contains mainly blood cells, and the other portion essentially contains the plasma part of the blood. The concentrated blood cells are led to an inner section of a dialysis apparatus and the plasma is directed to an outer section. Dialysis fluid is circulated in a countercurrent direction on an outer side of a membrane for both the inner and outer sections. Back filtration occurs into the concentrated blood cells in the inner section, as well as dialysis by diffusion. In the outer section, the plasma is treated by means of dialysis, which is facilitated in the absence of blood cells. However, the cleaning efficiency with respect to urea in the inner section is reduced due to the higher blood cell and protein concentrations. Hence, the overall blood cleaning efficiency is reduced. Nevertheless, this method implies treating both fractions by the same method, i.e. dialysis consisting of diffusion, ultrafiltration and convection.

### SUMMARY OF THE INVENTION

The object of the present invention is therefore to alleviate the efficiency problems discussed above, and thus accomplish an improved solution for all kinds of extracorporeal blood cleaning.

According to one aspect of the invention, the object is achieved by the initially described apparatus, wherein the first processing branch includes at least one first processing unit, which is adapted to remove cell-bound substances from the blood cells according to a first cleaning process and thus produce resulting washed blood cells. The second processing branch includes at least one second processing unit, which is adapted to remove toxins bound on proteins within the plasma and/or toxins dissolved in the plasma according to a second cleaning process, which is different from the first cleaning process.

An important advantage attained by this design is that each of the first and second processes can be tailored for an optimal cleaning of the blood cells and the plasma respectively. For instance, processing strategies that are per se very efficient, however harmful to one of the blood fractions may be applied to the other fraction without causing any damage to the resulting whole blood. Moreover, certain treatments of the plasma fraction may be more difficult, or more expensive, to perform in the presence of cell fractions, and vice versa. Naturally, this processing vouches for a very high overall toxin removal rate.

It is worth noting that the proposed dividing-off of the first and second fractions from the incoming blood does not preclude that further fractions in addition to the above-mentioned two fractions are divided off from the incoming blood, and that also these fractions are treated separately. For example, the blood cells may be sub-divided into red cells and white cells, so that at least one of the different cell types can be treated by means of a process being optimized for this type of cells. Moreover, in the mixing of the cleaned fractions one or more of any such sub-fractions may be left out.

According to one preferred embodiment of this aspect of the invention, the first processing branch includes a convection unit, which is adapted to remove the cell-bound substances from within the blood cells of the first fraction by means of a concentration-based cleaning process that operates over the cell membranes by causing an increased convection due to osmotic forces. Thereby, the removal rate of any toxins residing in the blood cells can be enhanced. A high osmolarity (i.e. salt content) is known to trigger the complement system. Therefore, it is an advantage not to have a high osmolarity in all of the blood. By separating blood cells and plasma into different fractions it is possible to decrease the volume faced with the high osmolarity, so that the complement system is less activated. It is also rendered easier to restore the osmolarity of the combined fractions to normal levels after the treatment when only one fraction has a high osmolarity, e.g. by keeping the other fraction(s) at a low osmolarity.

According to another preferred embodiment of this aspect of the invention, the first processing branch includes a first drug-inserting unit, which is adapted to add at least one input substance to the first fraction so as to produce a resulting pre-processed first fraction. This is advantageous because hence the toxin extraction process from the pre-processed first fraction may be facilitated, for example by adding an input substance that is adapted to enhance a removal rate of toxins from within the blood cells.

According to yet another preferred embodiment of this aspect of the invention, the input substance is adapted to influence the cell membranes of the blood cells of the first fraction, e.g. by increasing the permeability of the ion channels in the membrane, and thereby increase the membranes' permeability with respect to at least one toxin. By performing this treatment on the first fraction containing blood cells, less of the needed substances are required than for treating an equivalent amount of whole blood. Hence, the treatment can be made more efficient and less expensive. With less substance added it is also easier to remove the substance after the treatment.

According to still another preferred embodiment of this aspect of the invention, the input substance contains Riboflavin. Consequently, the pre-processed first fraction is a Riboflavin-containing fluid. Moreover, the first processing branch includes a light-processing unit, which is adapted to receive the pre-processed first fraction, and illuminate the pre-processed first fraction to generate a resulting first cleaned fraction. The first cleaned fraction has a bacteria concentration, which is lower than a bacteria concentration in the pre-processed first fraction. Thus, a reliable and straightforward bacteria reduction stage is attained.

According to another preferred embodiment of this aspect of the invention, the first processing branch includes an ultrasound unit. This unit is adapted to receive the first fraction, and expose the first fraction to ultrasonic energy. As a result, the blood cells' membrane permeability increases with respect to at least one toxin. Naturally, this vouches for an improved removal rate for the toxins in question.

According to a further preferred embodiment of this aspect of the invention, the first processing branch includes an electro-poring unit. This unit is adapted to receive the first fraction, and expose the first fraction to an electric field, so as to increase the permeability of the cell membranes of the blood cells in the first fraction with respect to at least one toxin. This constitutes an alternative, or a complement means to increase the toxin removal rate. Both the above-mentioned ultrasound and electric field treatments are relatively simple due to the comparatively small volume resulting from treating only one fraction, i.e. the first fraction containing blood cells. Namely, a small volume facilitates reaching high ultrasonic energy levels and high electric-field strength for the electroporation respectively.

According to another preferred embodiment of this aspect of the invention, the first processing branch includes a chemotherapy unit, which is adapted to receive the first fraction. The chemotherapy unit is also adapted to expose the first fraction to a cancer treatment drug, so as to reduce an amount of cancer-damaged cells among the blood cells in the first fraction. This treatment is advantageous in that relatively high doses of therapy (i.e. high drug concentrations) can be used without subjecting the patient to an elevated risk of side effects, since the drug concentration can be reduced again in connection with combining the first and second fractions before returning the whole blood to the patient. A cleaning unit may also be included in the processing chain before returning the blood to the patient.

According to yet another preferred embodiment of this aspect of the invention, the first processing branch includes a gas-induction unit, which is adapted to receive the first fraction. The gas-induction unit is also adapted to induce carbon dioxide into the first fraction, so as to alter an intracellular pH level of the blood cells in the first fraction, and thereby enable an efficient removal of uremic toxins. This embodiment is particularly advantageous if an alkalotic plasma fraction is used because then the resulting whole blood may have a physiological pH level.

According to still another preferred embodiment of this aspect of the invention, the second processing branch includes a dialysis unit, which is adapted to produce the second cleaned fraction based on a hemodialysis process, a hemofiltration process or a hemodiafiltration process. Namely, all these processes represent efficient blood plasma purification strategies.

According to yet another preferred embodiment of this aspect of the invention, the dialysis unit is adapted to operate with a dialysis fluid having a level of electrolytes significantly lower than the physiological levels of a human being. Thereby, large fluid amounts can be used at a low cost. Operating the process is also made easier, since no dosing calculation is required. Furthermore, the dialysis unit is preferably adapted to operate with a dialysis fluid, which has a temperature significantly lower than a normal body temperature of a human being (i.e. a cold dialysis fluid). Hence, the power consumption can be held relatively low.

According to another preferred embodiment of this aspect of the invention, the second processing branch includes an acid-level-adjustment unit, which is adapted to lower the pH level of the second fraction significantly. This will decrease the binding of toxins to proteins, and thus the removal of the toxins is increased. Normally, exceedingly low pH levels would be harmful to the blood cells. However, since here, only the plasma is affected, this strategy becomes much less problematic.

According to still another preferred embodiment of this aspect of the invention, the acid-level-adjustment unit is adapted to lower the pH level of the second fraction to approximately 3-5. Thereby good plasma purification can be realized.

According to a further preferred embodiment of this aspect of the invention, the second processing branch includes an acid-level-adjustment unit, which instead is adapted to increase the pH level of the second fraction to approximately 8-12, or more preferably to a level falling within the interval 9-11. Namely, some undesired substances are removed more efficiently in a basic environment.

According to yet another preferred embodiment of this aspect of the invention, the second processing branch includes a second drug-inserting unit, which is adapted to add at least one input substance to the second fraction. As a result, a pre-processed second fraction is produced. Preferably, the input substance is adapted to reduce a protein binding of at least one component of the plasma in the second fraction. In the absence of blood cells, the input substances can be selected relatively freely to attain a desired cleaning effect.

According to one further preferred embodiment of this aspect of the invention, the input substance (e.g. caffeine) is adapted to compete with albumin as a carrier of at least one toxin in the plasma of the second fraction. Thereby, the toxins will be inclined to bind to the input substance instead, which will produce a carrier-toxin complex that is much smaller than albumin, and can therefore be more easily removed. Moreover, it is desired that albumin is not removed.

According to another preferred embodiment of this aspect of the invention, the second processing branch includes a light-processing unit. This unit is adapted to receive the second fraction, and illuminate the second fraction to generate a resulting pre-processed second fraction. Here, the pre-processed second fraction has a concentration of at least one light-sensitive toxin, which is lower than a concentration of the at least one light-sensitive toxin in the second fraction. An important advantage attained by dividing off the blood cells from the plasma is that incident light can reach the light-sensitive toxin (e.g. bilirubin) in the plasma comparatively easily. Hence, the binding of the light-sensitive toxin to albumin can be broken up more efficiently.

According to still another preferred embodiment of this aspect of the invention, the second processing branch includes an adsorption unit. This unit is adapted to receive the second fraction, or a pre-processed fraction thereof, and adsorb at least one toxin in the plasma. As a result, the second cleaned fraction is produced. For example, the adsorption unit may include at least one positively charged adsorption zone, which is adapted to capture negatively charged toxins in the plasma of the second fraction. Alternatively, or as a complement thereto, the adsorption unit may include at least one adsorption column, which is adapted to reduce the concentration of at least one toxin in the plasma of the second fraction. Also these strategies benefit from the absence of blood cells because such cells tend to attach to the adsorbing surfaces, and thereby both risk to become damaged and reduce the function of the adsorbing surfaces.

According to yet another preferred embodiment of this aspect of the invention, the second processing branch includes an electrodialysis dialysis unit including a dialysis membrane. The electrodialysis unit is adapted to receive either the second fraction, or a pre-processed fraction thereof. The electrodialysis unit is adapted to hold the dialysis membrane at an electrical tension, so as to remove charged substances from the plasma, and as a result produce the second cleaned fraction. For example, this strategy is well suited to remove glycosylated proteins from the plasma, since these proteins alter their charge when being glycosylated. Glycosylated proteins are precursors to so-called advanced glycosylation end products (AGEs), a group of substances considered to be detrimental to patients. Having the blood cells separated from the plasma renders it possible to further increase the efficiency by using higher electrical currents, which would otherwise risk killing the blood cells. A lowered pH also assists to reverse the glycosylation. Thus, this embodiment of the invention is preferably combined with the above-described acid-level-adjustment unit. Furthermore, the electrodialysis of the plasma-containing second fraction may be simplified if the dialysis fluid contains no, or a relatively small amount of, electrolytes because these are affected by the electrical tension of the membrane.

According to a further preferred embodiment of this aspect of the invention, the second processing branch includes a heating unit, which is adapted to receive the second fraction. The heating unit is adapted to elevate the temperature of the plasma, so as to reduce an amount of bacteria therein, and as a result produce the second cleaned fraction. This processing is advantageous because with the blood cells removed, bacteria's higher sensitivity to heat and pressure variations can be used to eliminate the bacteria, for instance by increasing the pressure at a temperature of, say 40-50° C. (i.e. an artificial fever). Consequently, this embodiment is suitable for treatment of patients suffering from sepsis.

According to yet another preferred embodiment of this aspect of the invention, the second processing branch includes an antioxidant-inducing unit, which is adapted to receive the second fraction. The antioxidant-inducing unit is also adapted to induce at least one antioxidant substance (e.g. Vitamin C, Vitamin E, N-acetylcystein, various catalases or superoxid dismutase) into the plasma. Namely, thereby an amount of free radicals in the plasma is reduced, and a resulting second cleaned fraction is obtained. This treatment is advantageous because it is simpler, less expensive and requires less amounts of the antioxidant substance than if whole blood was treated. Although it is true that also the intracellular pool of antioxidants, such as glutathion, can be positively influenced in the blood-cell-containing first fraction by treatments of drugs, these drugs, in order to be efficient, are different from the antioxidants relevant to add to the plasma. Therefore, the proposed separation is still highly advantageous.

According to another aspect of the invention the object is achieved by the initially described method, wherein the processing of the first fraction involves removal of cell-bound substances from the blood cells of the first fraction according, such that the first cleaned fraction contains washed blood cells. The processing of the second fraction involves a second cleaning process, which is different from the first cleaning process, and this process removes toxins bound on proteins within the plasma and/or toxins dissolved in the plasma.

The advantages of this method, as well as the preferred embodiments thereof, are apparent from the discussion hereinabove with reference to the proposed apparatus.

Generally, the invention enables highly efficient, reliable and cost-effective extracorporeal blood cleaning for many purposes of which dialysis is one very important example.

Further advantages, advantageous features and applications of the present invention will be apparent from the following description and the dependent claims.

### BRIEF DESCRIPTION OF THE DRAWINGS

The present invention is now to be explained more closely by means of preferred embodiments, which are disclosed as examples, and with reference to the attached drawings.

FIG. 1 shows a block diagram over an apparatus for extracorporeal blood cleaning according to one embodiment of the invention, and

FIG. 2 shows a flow diagram which illustrates the general method according to the invention.

### DESCRIPTION OF PREFERRED EMBODIMENTS OF THE INVENTION

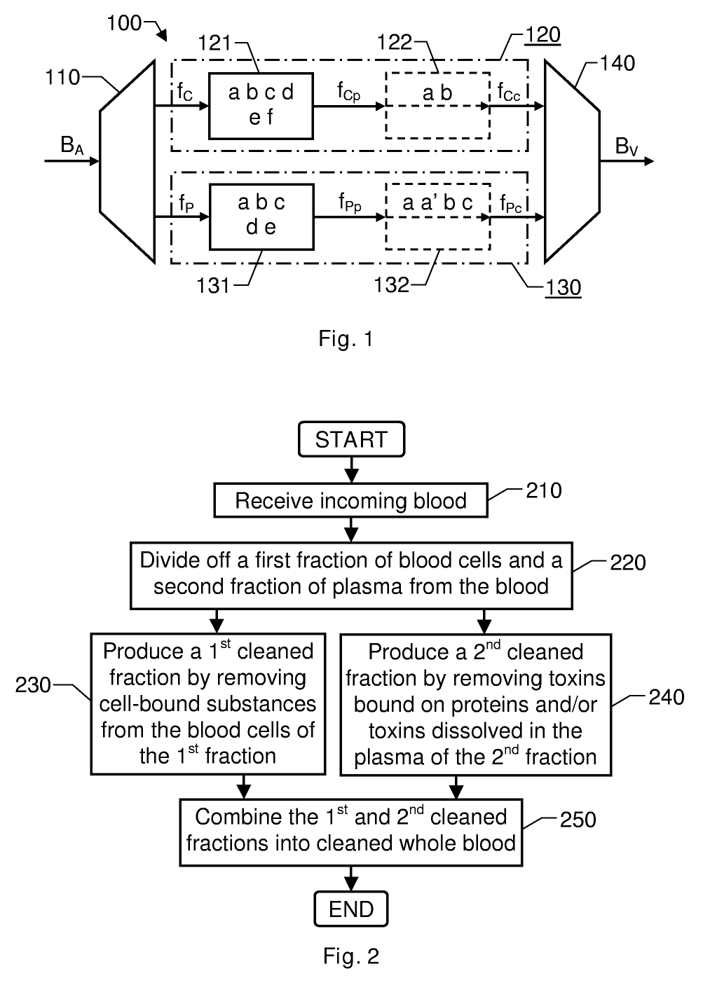

FIG. 1 shows a block diagram over an apparatus 100 for extracorporeal blood cleaning according to one embodiment of the invention. The apparatus 100 includes a separation unit 110, a first processing branch 120, a second processing branch 130 and a mixing unit 140.

The separation unit 110 is adapted to receive incoming blood B_{A} and separate this blood into a first fraction f_{C} containing predominantly blood cells, and a second fraction f_{P} containing predominantly blood plasma. To this aim, the separation unit 110 may include a centrifuge, an ultrasound unit (e.g. of the type described in the document U.S. Pat. No. 6,929,750) or a filter having a sufficiently high cutoff to allow the passage of albumin, however not blood cells. Preferably, however not necessarily, the filter is adapted to also hinder larger proteins, such as globulins, having a molecular weight above 100 kDa.

The first processing branch 120 includes at least one first processing unit 121, 122, which is adapted to receive the first fraction f_{C}, process the first fraction f_{C} according to a first cleaning process, and output a first cleaned fraction f_{Cc}. In the first cleaning process, the first processing unit(s) 121, and possibly 122, remove cell-bound substances from the blood cells, and produce resulting washed blood cells representing the first cleaned fraction f_{Cc}.

The second processing branch 130 includes at least one second processing unit 131, 132, which is adapted to remove toxins bound on proteins within the plasma and/or toxins dissolved in the plasma. The processing units 131, 132 operate according to a second cleaning process, which is different from the first cleaning process, to process the second fraction f_{P} and output a second cleaned fraction f_{Pc}.

The mixing unit 140 is adapted to receive the first and second cleaned fractions f_{Cc} and f_{Pc}, and physically combine these fractions. To this aim, the unit 140 preferably includes conventional fluid mixing means to accomplish a uniform cleaned whole blood B_{V} to be output from the apparatus 100.

Below, we will describe particular examples of processing units 121, 122, 131 and 132 that may be included in the processing branches 120 and 130 according to embodiments of the invention. The apparatus 100 may thus contain a number of specific units 121a, 121b, 121c, 121d, 121e, 121f, 122a, 122b, 131a, 131b, 131c, 131d, 131e, 132a 132a′, 132b and 132c that are employed in combination with one another in one or more different configurations.

According to one embodiment, the first processing branch 120 includes a convection unit 121a, which is adapted to remove the cell-bound substances from within the blood cells of the first fraction f_{C} by means of a concentration-based cleaning process operating over the cell membranes. The convection unit 121a may employ a high ion concentration (e.g. salt based) to extract cell-bound substances like Creatinine from the blood cells in the first fraction f_{C}. Provided that salt, or similar, is added, an appropriate secondary processing unit 122b may need to be included in the processing branch 120 to remove the undesired substances along with any additives. Nevertheless, no extra processing may be required in the processing branch 120 if the plasma fraction in the second processing branch 130 is dialyzed against a fluid containing no, or only a small amount of, electrolytes. Then, the electrolyte content can be made correct after the mixing back to whole blood. Thus, either an appropriate processing is performed by the secondary processing unit 122b, or the treatment of the plasma fraction as such result in a treated plasma with a sufficiently low content of the salts in question, or similar.

According to one embodiment, either as a complement or as an alternative to the above, the first processing branch 120 includes a first drug inserting unit 121b, which is adapted to add at least one input substance to the first fraction f_{C}. As a result, a pre-processed first fraction f_{Cp} is produced. The pre-processed first fraction f_{Cp} may then be processed further to obtain the first cleaned fraction f_{Cc}. Preferably, the at least one input substance is adapted to enhance a removal rate of toxins from within the blood cells of the first fraction f_{C}. To this aim, it is desirable if the input substance is adapted to influence the cell membranes of the blood cells of the first fraction f_{C}, so as to increase the membranes' permeability with respect to at least one toxin. For example, the permeability of the ion channels in the membrane may be increased.

The input substance may be Riboflavin (i.e. vitamin B2), and the first processing branch 120 may contain a light processing unit 122a. Thus, here, the pre-processed first fraction f_{Cp} is a Riboflavin-containing fluid. Moreover, the light processing unit 122a is adapted to receive the pre-processed first fraction f_{Cp} and illuminate this fraction to generate a resulting first cleaned fraction f_{Cc}. The light processing unit 122a emits such light that after the illumination, the first cleaned fraction f_{Cc} has a bacteria concentration which is lower than a bacteria concentration in the pre-processed first fraction f_{Cp}.

According to one embodiment, either as a complement or as an alternative to the above, the first processing branch 120 includes an ultrasound unit 121c. This unit is adapted to receive the first fraction f_{C} and expose the fraction to ultrasonic energy, so as to increase the permeability of the cell membranes of the blood cells therein with respect to at least one toxin.

Alternatively, or as a complement thereto, the first processing branch 120 may include an electroporing unit 121d, which is adapted to receive the first fraction f_{C} and expose the first fraction f_{C} to an electric field. As a result, the permeability of the cell membranes of the blood cells in the first fraction f_{C} is increased with respect to at least one toxin.

Alternatively, or as yet another complement, the first processing branch 120 may include a chemotherapy unit 121e, which is adapted to receive the first fraction f_{C} and expose it to a cancer treatment drug. As a result, an amount of cancer-damaged cells is reduced among the blood cells in the first fraction f_{C}. Of course, this treatment is well suited for patients suffering from leukemia.

According to another embodiment of the invention, either as a complement or as an alternative to the above, the first processing branch 120 includes a gas-induction unit 121f, which is adapted to receive the first fraction f_{C}. The unit 121f then induces carbon dioxide into the first fraction f_{C}, so as to alter an intracellular pH level of the blood cells in the first fraction f_{C}. As a result, an efficient removal of uremic toxins is enabled.

In any of the above-described embodiments wherein the toxin removal rate from within the blood cells is enhanced, the first processing branch 120 may also include at least one secondary processing unit, e.g. a dialysis unit, to perform the actual removal of the toxins from the first fraction f_{C}.

According to one embodiment, either as a complement or as an alternative to the above, the second processing branch 130 includes a dialysis unit 132a. This unit is adapted to produce the second cleaned fraction f_{Pc} based on a hemodialysis process, a hemofiltration process or a hemodiafiltration process. Preferably, the dialysis unit 132a is adapted to operate with a dialysis fluid having a level of electrolytes that is significantly lower than the physiological levels of a human being. Namely, thereby large fluid amounts can be used at a low cost. Moreover, since no dosing calculation is required the practical operation of the process is rendered easier as well. As mentioned above, the osmolarity needs to be restored in the whole blood resulting from the combination of the cleaned fractions. This restoration may be performed with aid from the first fraction containing blood cells in case the second fraction has been treated with a high salt content. Alternatively, the restoration can be made at the end of the second processing branch 130 before combining the fractions in the mixing unit 140. This requires a considerably smaller amount of salt than if all of the treatment fluid has a physiological level of salt.

According to one preferred embodiment of the invention, the dialysis unit 132a is adapted to operate with a dialysis fluid that has a relatively low temperature being significantly lower than a normal body temperature of a human being (i.e. a cold dialysis fluid). This is advantageous with respect to power consumption and cost. However, the temperature needs to be restored if the whole blood is to be returned to a patient. Such a restoration may only partly be completed with respect to the blood cell containing fraction, since the blood cells cannot tolerate an elevated temperature. Nevertheless, again the restoration can be made at the end of the second processing branch 130, and this consumes much less power than performing the whole dialysis procedure at physiological temperatures, i.e. around 37° C.

According to one embodiment, either as a complement or as an alternative to the above, the second processing branch 130 includes an acid-level-adjustment unit 131a, which is adapted to lower the pH level of the second fraction f_{P} significantly. Preferably, the pH level is lowered to a value in the range from approximately pH 3 to approximately pH 5. According to preferred embodiments of the invention, the acid-level-adjustment unit 131a is adapted to infuse citric acid and/or hydrochloric acid to accomplish the desired decrease of the pH level. Lactic acid and acetic acid constitute other examples of acids that are possible to use in connection with dialysis, however these acids are less physiologic. Pyruvic acid could also be used.

As an alternative, citric acid may be used as a combined anticoagulant pH-level decreasing substance. However, this requires that the citric acid be infused directly when the blood is drawn from the patient in order for the anticoagulation to work.

In this embodiment, the second processing branch 130 may also include the dialysis unit 132a and a pH-level restoration unit 132a′ adapted to raise the pH level to a normal value (e.g. pH 7.0 to pH 7.8) before passing the second cleaned fraction f_{Pc} to the mixing unit 140. The pH-level restoration unit 132a′ may be adapted to infuse bicarbonate to attain this neutralizing effect.

To create a basic environment and thus remove certain undesired substances from the plasma, according to yet another embodiment of the invention, the second processing branch includes an acid-level-adjustment unit 131a, which is adapted to increase the pH level of the second fraction f_{P}. Preferably, the pH level is here raised to an interval ranging from approximately 8 to approximately 12, or more preferably to a level falling within the interval 9-11.

According to one embodiment, either as a complement or as an alternative to the above, the second processing branch 130 includes a second drug inserting unit 131b. The unit 131b is adapted to add at least one input substance to the second fraction f_{P}, and thus produce a resulting pre-processed second fraction f_{Pp}. The above-described dialysis unit 132a may then be used to remove the drug along with other toxins in the plasma.

Preferably, the input substance is adapted to reduce a protein binding of at least one component of the plasma in the second fraction f_{P}. Alternatively, the input substance, e.g. represented by caffeine, may be adapted to compete with albumin as a carrier of at least one toxin in the plasma of the second fraction f_{P}. Thereby, a secondary processing unit 132 may remove any protein-bound substances relatively easily from the second fraction f_{P}.

According to one embodiment, either as a complement or as an alternative to the above, the second processing branch 130 includes a light processing unit 131c. This unit is adapted to receive the second fraction f_{P} and illuminate the fraction to generate a resulting pre-processed second fraction f_{Pp}. This illumination may cause a breakdown of light-sensitive toxins into less tightly bound breakdown products, which are easier to remove. One example is bilirubin, which breaks down to form the more water-soluble lumirubin. According to one preferred embodiment of the invention, the light processing unit 131c is adapted to produce light containing relatively large amounts of energy around 450 nm (i.e. near the ultraviolet range), where bilirubin has its absorption peak. Namely, by illuminating the second fraction f_{P} with such light the bilirubin therein can be transformed into lumirubin. Lumirubin is water soluble, and may thus be removed efficiently by means of standard hemodialysis, hemofiltration or hemodiafiltration processing, for example implemented by the above-described dialysis unit 132a.

Nevertheless, the pre-processed second fraction f_{Pp} has a concentration of bilirubin, or other light-sensitive toxin (depending on the light used), which is lower than a concentration of the at least one light-sensitive toxin in the second fraction f_{P}.

According to one embodiment, either as a complement or as an alternative to the above, the second processing branch 130 includes an adsorption unit 132b. This unit is adapted to receive either the second fraction f_{P}, or a pre-processed fraction thereof f_{Pp} (e.g. produced by the acid-level-adjustment unit 131a, the second drug inserting unit 131b or the light processing unit 131c), and adsorb at least one toxin in the plasma. As a result, the adsorption unit 132b produces the second cleaned fraction f_{Pc}. The adsorption unit 132b, in turn, may include at least one positively charged adsorption zone, which is adapted to capture negatively charged toxins in the plasma of the second fraction f_{P}. Alternatively, the adsorption unit 132b may include at least one adsorption column, which is adapted to reduce the concentration of at least one toxin in the plasma of the second fraction f_{P}. As mentioned earlier, in this treatment it is advantageous not to have any blood cells present.

According to another embodiment of the invention, either as a complement or as an alternative to the above, the second processing branch 130 includes an electrodialysis unit 132c. This unit, in turn, has a dialysis membrane to which an electrical tension may be applied. Specifically, the electrodialysis unit 132c is adapted to receive the second fraction f_{P}, or a pre-processed fraction thereof f_{Pp}, and hold the dialysis membrane at an electrical tension. Thereby, charged substances are removed from the plasma and a resulting second cleaned fraction f_{Pc} is produced.

In another embodiment of the invention, the second processing branch 130 includes, either as a complement or as an alternative to the above, a heating unit 131d. This unit is adapted to receive the second fraction f_{P} and elevate the temperature of the plasma. Thereby, an amount of bacteria in the plasma may be reduced to produce the second cleaned fraction f_{Pc}. Preferably, the pressure of the plasma is increased at a temperature of 40-50° C.

According to yet another embodiment of the invention, the second processing branch 130 comprises an antioxidant inducing unit 131e. Also this unit may be combined with one or more of the above-described units. The antioxidant inducing unit 131e is adapted to receive the second fraction f_{P}, and induce at least one antioxidant substance into the plasma. As a result, an amount of free radicals in the plasma is reduced, such that it may constitute the second cleaned fraction f_{Pc}. Vitamin C, Vitamin E, N-acetylcystein, various catalases and/or superoxid dismutase may preferably be used as the antioxidant substance.

In order to sum up, the general method for extracorporeal blood cleaning according to the invention will be described below with reference to the flow diagram in FIG. 2.

A first step 210 receives incoming blood. A following step 220 divides off a first fraction from the blood, where the first fraction contains predominantly blood cells. The step 220 also divides off a second fraction containing predominantly blood plasma. Then, a step 230 processes the first fraction according to a first cleaning process by removing cell-bound substances from the blood cells to produce a first cleaned fraction containing washed blood cells. Preferably in parallel with the step 230, a step 240 processes the second fraction by removing toxins bound on proteins within the plasma and/or toxins dissolved in the plasma to produce a second cleaned fraction. The processing in the step 240 is different from the processing in the step 230. Furthermore, each of the steps 230 and 240 is adapted to optimize the treatment according to the characteristics of the respective fraction. Finally, a step 250 combines the first and second cleaned fractions into cleaned whole blood.

The term “comprises/comprising” when used in this specification is taken to specify the presence of stated features, integers, steps or components. However, the term does not preclude the presence or addition of one or more additional features, integers, steps or components or groups thereof.

The invention is not restricted to the described embodiments in the figures, but may be varied freely within the scope of the claims.

1. An apparatus for extracorporeal blood cleaning comprising:
a separation unit configured to receive incoming blood, said separation unit being configured to separate the blood into a first fraction containing predominantly blood cells and a second fraction containing predominantly blood plasma;
a first processing branch configured to receive the first fraction, process the first fraction according to a first cleaning process, and output a first cleaned fraction;
a second processing branch configured to receive the second fraction, process the second fraction, and output a second cleaned fraction; and
a mixing unit configured to receive the first and second cleaned fractions, combine the first and second cleaned fractions, and output cleaned whole blood, wherein
the first processing branch comprises at least one first processing unit configured to remove cell-bound substances from the blood cells, and to produce resulting washed blood cells (f_{Cc}); and
the second processing branch comprises at least one second processing unit configured to remove at least one of toxins bound on proteins within the plasma and toxins dissolved in the plasma according to a second cleaning process different from the first cleaning process.

2. The apparatus according to claim 1, wherein the first processing branch comprises a convection unit configured to remove the cell-bound substances from within the blood cells of the first fraction by means of a concentration-based cleaning process operating over cell membranes of the blood cells.

3. The apparatus according to any one of the claims 1 or 2, wherein the first processing branch comprises a first drug inserting unit configured to add at least one input substance to the first fraction so as to produce a resulting pre-processed first fraction.

4. The apparatus according to claim 3, wherein the at least one input substance is configured to enhance a removal rate of toxins from the blood cells of the first fraction.

5. The apparatus according to claim 3, wherein the at least one input substance is adapted to influence cell membranes of the blood cells of the first fraction so as to increase a permeability of the cell membranes with respect to at least one toxin.

6. The apparatus according to claim 3, wherein the at least one input substance comprises Riboflavin, the pre-processed first fraction is a Riboflavin-containing fluid, and the first processing branch comprises a light processing unit configured to:
receive the pre-processed first fraction,
and illuminate the pre-processed first fraction to generate a resulting first cleaned fraction having a bacteria concentration which is lower than a bacteria concentration in the pre-processed first fraction.

7. The apparatus according to claim 1, wherein the first processing branch comprises an ultrasound unit configured to:
receive the first fraction, and
expose the first fraction to ultrasonic energy so as to increase the permeability of cell membranes of the blood cells in the first fraction with respect to at least one toxin.

8. The apparatus according to claim 1, wherein the first processing branch comprises an electroporing unit configured to:
receive the first fraction, and
expose the first fraction to an electric field so as to increase the permeability of cell membranes of the blood cells in the first fraction with respect to at least one toxin.

9. The apparatus according to claim 1, wherein the first processing branch comprises a chemotherapy unit configured to:
receive the first fraction, and
expose the first fraction to a cancer treatment drug so as to reduce an amount of cancer-damaged cells among the blood cells in the first fraction.

10. The apparatus according to claim 1, wherein the first processing branch comprises a gas-induction unit configured to:
receive the first fraction, and
induce carbon dioxide into the first fraction so as to alter an intracellular pH level of the blood cells in the first fraction to enable an efficient removal of uremic toxins.

11. The apparatus according to claim 1, wherein the second processing branch comprises a dialysis unit configured to produce the second cleaned fraction based on at least one of a hemodialysis process, a hemofiltration process, and a hemodiafiltration process.

12. The apparatus according to claim 11, wherein the dialysis unit is configured to operate with a dialysis fluid having a level of electrolytes significantly lower than physiological levels of a human being.

13. The apparatus according to claim 11, wherein the dialysis unit is configured to operate with a dialysis fluid having a temperature significantly lower than a normal body temperature of a human being.

14. The apparatus according to claim 1, wherein the second processing branch comprises an acid-level-adjustment unit configured to lower the pH level of the second fraction significantly.

15. The apparatus according to claim 14, wherein the acid-level-adjustment unit is configured to lower the pH level of the second fraction to a level falling within an interval from approximately 3 to approximately 5.

16. The apparatus according to claim 1, wherein the second processing branch comprises an acid-level-adjustment unit configured to increase the pH level of the second fraction to a level falling within an interval from approximately 8 to approximately 12.

17. The apparatus according to claim 1, wherein the second processing branch comprises a second drug inserting unit configured to add at least one input substance to the second fraction so as to produce a resulting pre-processed second fraction.

18. The apparatus according to claim 17, wherein the at least one input substance is adapted to reduce a protein binding of at least one component of the plasma in the second fraction.

19. The apparatus according to claim 17, wherein the at least one input substance is adapted to compete with albumin as a carrier of at least one toxin in the plasma of the second fraction.

20. The apparatus according to claim 1, wherein the second processing branch comprises a light-processing unit configured to:
receive the second fraction, and
illuminate the second fraction to generate a resulting pre-processed second fraction having a concentration of at least one light-sensitive toxin which is lower than a concentration of the at least one light-sensitive toxin in the second fraction.

21. The apparatus according to claim 1, wherein the second processing branch comprises an adsorption unit configured to:
receive the second fraction or a pre-processed fraction of the second fraction, and
adsorb at least one toxin in the plasma so as to produce the second cleaned fraction.

22. The apparatus according to claim 21, wherein the adsorption unit comprises at least one positively charged adsorption zone configured to capture negatively charged toxins in the plasma of the second fraction.

23. The apparatus according to claim 21 or 22, wherein the adsorption unit comprises at least one adsorption column configured to reduce the concentration of at least one toxin in the plasma of the second fraction.

24. The apparatus according to claim 1, wherein the second processing branch comprises an electrodialysis unit including a dialysis membrane, the electrodialysis unit being configured to:
receive the second fraction or a pre-processed fraction of the second fraction, and
hold the dialysis membrane at an electrical tension so as to remove charged substances from the plasma, and produce the second cleaned fraction.

25. The apparatus according to claim 1, wherein the second processing branch comprises a heating unit configured to:
receive the second fraction, and
elevate the temperature of the plasma so as to reduce an amount of bacteria in the plasma, and produce the second cleaned fraction.

26. The apparatus according to claim 1, wherein the second processing branch comprises an antioxidant-inducing unit configured to:
receive the second fraction, and
induce at least one antioxidant substance into the plasma so as to reduce an amount of free radicals in the plasma, and produce the second cleaned fraction.

27. A method for extracorporeal blood cleaning, comprising:
receiving incoming blood;
separating a first fraction from the incoming blood, the first fraction containing predominantly blood cells,
separating a second fraction from the incoming blood, the second fraction containing predominantly blood plasma;
processing the first fraction in a first processing branch according to a first cleaning process to produce a first cleaned fraction;
processing the second fraction in a second processing branch to produce a second cleaned fraction; and
combining the first and second cleaned fractions, into cleaned whole blood,
wherein
the processing of the first fraction comprising removal of cell-bound substances from the blood cells of the first fraction such that the first cleaned fraction contains washed blood cells,
and the processing of the second fraction (f_{P}) comprises at least one of removal of toxins bound on proteins within the plasma and removal of toxins dissolved in the plasma, the processing of the second fraction being performed according to a second cleaning process different from the first cleaning process.

28. The method according to claim 27, wherein the removal of cell-bound substances from within the blood cells of the first fraction comprises a concentration-based cleaning process operating over cell membranes of the blood cells.

29. The method according to claim 27 or 28, wherein the processing in the first processing branch comprises addition of at least one input substance to the first fraction to produce a resulting pre-processed first fraction.

30. The method according to claim 29, wherein the at least one input substance is adapted to enhance a removal rate of toxins from the blood cells.

31. The method according to claim 29, wherein the at least one input substance is adapted to influence the cell membranes of the blood cells of the first fraction so as to increase the permeability of the cell membranes with respect to at least one toxin.

32. The method according to claim 29, wherein the at least one input substance comprises riboflavin and the pre-processed first fraction is a riboflavin-containing fluid, the processing of the first fraction comprising:
receiving the pre-processed first fraction, and
illuminating the pre-processed first fraction to generate a resulting first cleaned fraction having a bacteria concentration which is lower than a bacteria concentration in the pre-processed first fraction.

33. The method according to claim 27, wherein the processing of the first fraction comprises exposing the first fraction to ultrasonic energy so as to increase the permeability of the cell membranes of the blood cells in the first fraction with respect to at least one toxin.

34. The method according to claim 27, wherein the processing of the first fraction comprises exposing the first fraction to an electric field so as to increase the permeability of the cell membranes of the blood cells in the first fraction with respect to at least one toxin.

35. The method according to claim 27, wherein the processing of the first fraction comprises exposing the first fraction to a cancer treatment drug so as to reduce an amount of cancer-damaged cells among the blood cells in the first fraction.

36. The method according to claim 27, wherein the processing of the first fraction comprises inducing carbon dioxide into the first fraction so as to alter an intracellular pH level of the blood cells in the first fraction.

37. The method according to claim 27, wherein the processing of the second fraction comprises at least one of a hemodialysis processing, a hemofiltration processing, and a hemodiafiltration processing to produce the second cleaned fraction.

38. The method according to claim 37, further comprising applying a dialysis fluid having a level of electrolytes significantly lower than physiological levels of a human being.

39. The method according to claim 37 or 38, further comprising applying a dialysis fluid having a temperature significantly lower than a normal body temperature of a human being.

40. The method according to claim 27, wherein the processing of the second fraction comprises lowering the pH level of the second fraction significantly.

41. The method according to claim 40, wherein the pH level of the second fraction is lowered to a level falling within an interval from approximately 3 to approximately 5.

42. The method according to claim 27, wherein the processing of the second fraction comprises increasing the pH level of the second fraction to a level falling within an interval from approximately 8 to approximately 12.

43. The method according to claim 27, wherein the processing of the second fraction comprises adding at least one input substance to the second fraction so as to produce a resulting pre-processed second fraction.

44. The method according to claim 43, wherein the at least one input substance is adapted to reduce a protein binding of at least one component of the plasma in the second fraction.

45. The method according to claim 43, wherein the at least one input substance is adapted to compete with albumin as a carrier of at least one toxin in the plasma of the second fraction.

46. The method according to claim 27, wherein the processing of the second fraction comprises illuminating the second fraction to generate a resulting pre-processed second fraction having a concentration of at least one light-sensitive toxin which is lower than a concentration of the at least one light-sensitive toxin in the second fraction.

47. The method according to claim 27, wherein the second cleaned fraction is produced by adsorbing at least one toxin in the plasma by means of at least one of a positively charged adsorption zone and an adsorption column.

48. The method according to claim 27, wherein the second cleaned fraction is produced by processing the second fraction by dialysis over a membrane held at an electrical tension.

49. The method according to claim 27, wherein the second cleaned fraction is produced by elevating the temperature of the plasma in the second fraction so as to reduce an amount of bacteria in the plasma.

50. The method according to claim 27, wherein the second cleaned fraction is produced by inducing at least one antioxidant substance into the plasma so as to reduce an amount of free radicals therein.
